(19) United States
(12) Patent Application Publication
(10) Pub. No.: US 2007/0138442 A1
(43) Pub. Date: Jun. 21, 2007

(54) Modified and doped solder alloys for electrical interconnects, methods of production and uses thereof

(76) Inventor: Martin W. Weiser, Liberty Lake, WA (US)

Correspondence Address: BUCHALTER NEMER, 18400 VON KARMAN AVE., SUITE 800, IRVINE, CA, 92612, US

(21) Appl. No.: 11/641,367

(22) Filed: Dec. 18, 2006

Related U.S. Application Data
(60) Provisional application No. 60/751,743, filed on Dec. 19, 2005.

(51) Int. Cl. H01B 1/12

(52) U.S. Cl. 252/500

(57) ABSTRACT

Solder compositions are described that include at least about 2% of silver, at least about 60% of bismuth, and at least one coupling element, wherein the at least one coupling element forms a complex with bismuth. Layered materials are also described that include a surface or substrate; an electrical interconnect; the solder composition described herein; and a semiconductor die or package. Methods of producing a solder composition are also described that include: a) providing at least about 2% of silver, b) providing at least about 60% of bismuth, c) providing at least one coupling element, wherein the at least one coupling element forms a complex with bismuth, and d) blending the silver, bismuth and at least one coupling element to form the solder composition.

This application is a Taiwan Application based on U.S. Provisional Application Ser. No.: 60/751743 filed on Dec. 19, 2005, which is commonly-owned and incorporated herein in its entirety.

### FIELD OF THE SUBJECT MATTER

The field of the invention is modified and/or doped lead-free thermal interconnect systems, thermal interface systems and interface materials in electronic components, semiconductor components and other related layered materials applications.

### BACKGROUND OF THE SUBJECT MATTER

Electronic components are used in ever increasing numbers of consumer and commercial electronic products. Examples of some of these consumer and commercial products are televisions, personal computers, Internet servers, cell phones, pagers, palm-type organizers, portable radios, car stereos, or remote controls. As the demand for these consumer and commercial electronics increases, there is also a demand for those same products to become smaller, more functional, and more portable for consumers and businesses.

As a result of the size decrease in these products, the components that comprise the products must also become smaller. Examples of some of those components that need to be reduced in size or scaled down are printed circuit or wiring boards, resistors, wiring, keyboards, touch pads, and chip packaging.

Components, therefore, are being broken down and investigated to determine if there are better building and intermediate materials, machinery and methods that will allow them to be scaled down to accommodate the demands for smaller electronic components. Part of the process of determining if there are better building materials, machinery and methods is to investigate how the manufacturing equipment and methods of building and assembling the components operates.

Numerous known die attach methods utilize a high-lead solder, solder compositions or solder material to attach the semiconductor die within an integrated circuit to a leadframe for mechanical connection and to provide thermal and electrical conductivity between the die and leadframe. Although most high-lead solders are relatively inexpensive and exhibit various desirable physico-chemical properties, the use of lead in die attach and other solders has come under increased scrutiny from an environmental and occupational health perspective. Consequently, various approaches have been undertaken to replace lead-containing solders with lead-free die attach compositions.

For example, in one approach, polymeric adhesives (e.g., epoxy resins or cyanate ester resins) are utilized to attach a die to a substrate as described in U.S. Pat. Nos. 5,150,195; 5,195,299; 5,250,600; 5,399,907 and 5,386,000. Polymeric adhesives typically cure within a relatively short time at temperatures generally below 200° C., and may even retain structural flexibility after curing to allow die attach of integrated circuits onto flexible substrates as shown in U.S. Pat. No. 5,612,403. However, many polymeric adhesives tend to produce resin bleed, potentially leading to undesirable reduction of electrical contact of the die with the substrate, or even partial or total detachment of the die.

To circumvent at least some of the problems with resin bleed, silicone-containing die attach adhesives may be utilized as described in U.S. Pat. No. 5,982,041 to Mitani et al. While such adhesives tend to improve bonding between the resin sealant and the semiconductor chip, substrate, package, and/or lead frame, the curing process for at least some of such adhesives requires a source of high-energy radiation, which may add significant cost to the die attach process.

Alternatively, a glass paste comprising a high-lead borosilicate glass may be utilized as described in U.S. Pat. No. 4,459,166 to Dietz et al., thereby generally avoiding a high-energy curing step. However, many glass pastes comprising a high-lead borosilicate glass require temperatures of 425° C. and higher to permanently bond the die to the substrate. Moreover, glass pastes frequently tend to crystallize during heating and cooling, thereby reducing the adhesive qualities of the bonding layer.

In yet another approach, various high melting solders are utilized to attach a die to a substrate or leadframe. Soldering a die to a substrate has various advantages, including relatively simple processing, solvent-free application, and in some instances relatively low cost. There are various high melting solders known in the art. However, all or almost all of them have one or more disadvantages. For example, most gold eutectic alloys (e.g., Au-20% Sn, Au-3% Si, Au-12% Ge, and Au-25% Sb) are relatively costly and frequently suffer from less-than-ideal mechanical properties. Alternatively, Alloy J (Ag-10% Sb-65% Sn, see e.g., U.S. Pat. No. 4,170,472 to Olsen et al.) may be used in various high melting solder applications. However, Alloy J has a solidus of 228° C. and also suffers from relatively poor mechanical performance.

For those components that require electronic interconnects, the spheres, balls, powder, preforms or some other solder-based component that can provide an electrical interconnect between two components are utilized. In the case of BGA spheres, the spheres form the electrical interconnect between a package and a printed circuit board and/or the electrical interconnection between a semiconductor die and package or board. The locations where the spheres contact the board, package or die are called bond pads. The interaction of the bond pad metallurgy with the sphere during solder reflow can determine the quality of the joint, and little interaction or reaction will lead to a joint that fails easily at the bond pad. Too much reaction or interaction of the bond pad metallurgy can lead to the same problem through excessive formation of brittle intermetallics or undesirable products resulting from the formation of intermetallics.

There are several approaches to correct and/or reduce some of the solder problems presented herein. For example, Japanese patent, JP07195189A, uses bismuth, copper and antimony simultaneously as dopants in a BGA sphere to improve joint integrity. Phosphorous may or may not be added; however, results in this patent show that phosphorus additions performed poorly. Phosphorus was added in high weight percentages, as compared to other components. Levels of copper ranged from 100 ppm to 1000 ppm.

In “Effect of Cu Concentration on the reactions between Sn—Ag—Cu Solders and Ni”, Journal of Electronic Materials, Vol. 31, No 6, p 584, 2002 by C. E. Ho,et. al, and Republic of China Patent 1490961 (Mar. 23, 2001); C. R. Kao and C. E Ho, the effect of copper additions on improving Sn—Pb eutectic performance on ENIG bond pads is investigated. Compositions comprising less than 2000 ppm Cu were not investigated.

Jeon, et. al, “Studies of Electroless Nickel Under Bump Metallurgy—Solder Interfacial Reactions and Their Effects on Flip Chip Joint Reliability”, Journal of Electronic Materials, pg 520-528, Vol 31, No 5, 2002, and Jeon et.al, “Comparison of Interfacial Reactions and Reliabilities of Sn3.5Ag and Sn4.0Ag0.5Cu and Sn0.7Cu Solder Bumps on Electroless Ni—P UBMs” Proceeding of Electronic Components and Technology Conference, IEEE, pg 1203, 2003 discuss that intermetallic growth is faster on pure nickel bond pads than electroless nickel bonds pads. The benefits of copper in concentrations of 0.5% (5000 ppm) or higher are also investigated and discussed in both articles.

Zhang, et.al, “Effects of Substrate Metallization on Solder/UnderBump Metallization Interfacial Reactions in Flip-Chip Packages during Multiple Reflow Cycles”, Journal of Electronic Materials, Vol 32, No 3, pg 123-130, 2003 shows there is no effect from phosphorus on slowing intermetallic consumption (which contradicts the Jeon article). Shing Yeh, “Copper Doped Eutectic Tin-Lead Bump for Power Flip Chip Applications”, Proceeding of Electronic Components and Technology Conference, IEEE, pg 338, 2003 notes that a 1% copper addition reduced nickel layer consumption.

The Niedrich patents and application (EP0400363 A1 EP0400363B1 and U.S. Pat. No. 5,011,658) show copper used as a dopant in Sn—Pb—In solders to minimize the consumption of copper bond pads or connectors (i.e., no nickel barrier layer is used). The copper in the solder was found to decrease the copper connector dissolution. Niedrich uses the copper to inhibit nickel barrier layer interaction through forming copper intermetallics or (Cu, Ni)Sn intermetallics. The Niedrich patents are very similar in their use of copper as U.S. Pat. No. 2,671,844, which adds copper to solder in amounts greater than 0.5 wt % to minimize dissolution of copper soldering iron tips during fine soldering operations.

The U.S. Pat. No. 4,938,924 by Ozaki noted that the addition of 2000-4000 ppm of copper improves wefting and long term joint reliability of in Sn-36Pb-2Ag alloys. Japanese Patent JP60166191A “Solder Alloy Having Excellent Resistance to Fatigue Characteristic” discloses a Sn Bi Pb alloy with 300-5000 ppm copper added to improve fatigue resistance.

U.S. Pat. No. 6,307,160 teaches the use of at least 2% indium to improve the bond strength of the eutectic Sn—Pb alloy on Electroless Nickel/Immersion Gold (ENIG) bond pads.

U.S. Pat. No. 4,695,428 “Solder Composition” discloses a Pb-free solder composition used for plumbing joints. The copper concentration used is in excess of 1000 ppm and several other elements are also added as alloying additions to improve the liquidus, solidus, flow properties and surface finish of the solder.

In bismuth-based solders, even those that contain silver, the thermal conductivity is quite low due to the low thermal conductivity of bismuth. These solders exhibit failure during thermal cycling along the interface. Currently, the primary cause is believed to be dissolution of the nickel metallization layer on the back die because of the formation of NiBi₃ intermetallics.

Thus, there is a continuing need to: a) develop lead-free modified solder materials that function in a similar manner as lead-based or lead-containing solder materials; b) develop modified solder materials that have no deleterious effects on bulk solder properties, yet slows the consumption of the nickel-barrier layer and hence, in some cases, growth of a phosphorus rich layer, so that bond integrity is maintained during reflow and post reflow thermal aging; c) design and produce electrical interconnects that meet customer specifications while minimizing the production costs and maximizing the quality of the product incorporating the electrical interconnects; and d) develop reliable methods of producing electrical interconnects and components comprising those interconnects.

### SUMMARY

Solder compositions are described that include at least about 2% of silver, at least about 60% of bismuth, and at least one coupling element, wherein the at least one coupling element forms a complex or compound with bismuth.

Layered materials are also described that include a surface or substrate; an electrical interconnect; the solder composition described herein; and a semiconductor die or package.

Methods of producing a solder composition are also described that include: a) providing at least about 2% of silver, b) providing at least about 60% of bismuth, c) providing at least one coupling element, wherein the at least one coupling element forms a complex with bismuth, and d) blending the silver, bismuth and at least one coupling element to form the solder composition.

### BRIEF DESCRIPTION OF THE FIGURES

FIG. 1 shows an Ag—Bi phase diagram.

FIG. 2 shows an electron micrograph, in which the Ag—Bi alloy appears to form a hypoeutectic alloy wherein the primary constituent (silver) is surrounded by fine eutectic structure.

FIG. 3 shows IMC thickness versus aging at 150° C.

FIG. 4 depicts thermal conductivity analysis results for some of the contemplated alloys using a laser flash method indicated thermal conductivity of at least 9 W/m K.

FIG. 5 depicts contemplated compositions (and materials comprising contemplated compositions), which may be utilized in an electronic device to bond a semiconductor die (e.g., silicon, germanium, or gallium arsenide die) to a leadframe as depicted.

### DESCRIPTION OF THE SUBJECT MATTER

Unlike the previously described references, modified solder materials are described herein that are lead free and that function in a similar manner as lead-based or lead-containing solder materials; that have no deleterious effects on bulk solder properties, yet slow the consumption of the nickel-barrier layer, so that bond integrity is maintained during reflow and post reflow thermal aging. These modified solders meet both goals of a) designing and producing electrical interconnects that meet customer specifications while minimizing the production costs and maximizing the quality of the product incorporating the electrical interconnects; and b) developing reliable methods of producing electrical interconnects and components comprising those interconnects.

Silver-bismuth solders are ideal solders to use in applications described herein, but problems are created when the solder comes in contact with nickel, such as a nickel-plated surface. Bismuth is notorious for reacting with nickel to form deleterious NiBi₃ intermetallics, and therefore, any modification of the solder which can slow down the growth of these intermetallics is desirable. Lead free solder compositions comprising bismuth and silver are described herein that also include at least one element, such as a coupling element, that not only creates an intermetallic with bismuth, but also creates a small chemical gradient for the reaction between the element and bismuth in order to slow the rate of growth of intermetallics in the solder. In addition, modified solders contemplated herein are substantially lead-free.

Solder compositions are described that include at least about 2% of silver, at least about 60% of bismuth, and at least one coupling element, wherein the at least one coupling element forms a complex or compound with bismuth or otherwise modify the bismuth-based intermetallic that has already formed or is forming. Layered materials are also described that include a surface or substrate; an electrical interconnect; the solder composition described herein; and a semiconductor die or package. Methods of producing a solder composition are also described that include: a) providing at least about 2% of silver, b) providing at least about 60% of bismuth, c) providing at least one coupling element, wherein the at least one coupling element forms a complex with bismuth, and d) blending the silver, bismuth and at least one coupling element to form the solder composition.

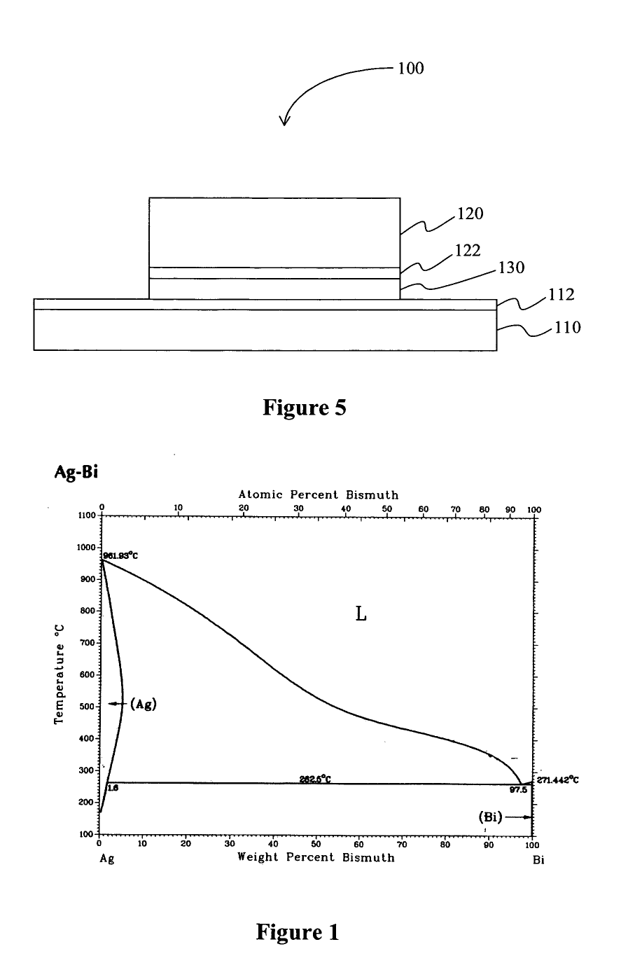

A group of contemplated compositions comprise alloys that may be used as solder and that comprise silver in an amount of about 2 wt % to about 34 wt % and bismuth in an amount of about 98 wt % to about 60 wt %. FIG. 1 shows an Ag—Bi phase diagram. In some embodiments, silver may be added in an amount up to about 34% with the remaining elements in the alloys comprising bismuth, at least one coupling element, and in some embodiments, at least one additional element. In some embodiments, bismuth is present in an amount of about 68.4 weight percent up to about 96.99 weight percent.

It should further be appreciated that addition of chemical elements or metals to improve one or more physico-chemical or thermo-mechanical properties can be done in any order so long as all components in the alloy are substantially (i.e., at least 95% of each component) molten, and it is contemplated that the order of addition is not limiting to the subject matter. Similarly, it should be appreciated that while it is contemplated that silver and bismuth are combined prior to the melting step, it is also contemplated that the silver and bismuth may be melted separately, and that the molten silver and molten bismuth are subsequently combined. A further prolonged heating step to a temperature above the melting point of silver may be added to ensure substantially complete melting and mixing of the components. It should be particularly appreciated that when one or more additional elements are included, the solidus of contemplated alloys may decrease. Thus, contemplated alloys with such additional alloys may have a solidus in the range of about 260-255° C., in the range of about 255-250° C., in the range of about 250-245° C., in the range of about 245-235° C., and even lower.

Compositions contemplated herein can be prepared by a) providing a charge of appropriately weighed quantities (supra) of the pure metals; b) heating the metals under vacuum or an inert atmosphere (e.g., nitrogen or argon) to between about 960° C.-1000° C. in a refractory or heat resistant vessel (e.g., a graphite crucible) until a liquid solution forms; and c) stirring the metals at that temperature for an amount of time sufficient to ensure complete mixing and melting of both metals. All of the elements are normally placed in the crucible and melted together, particularly when done in vacuum or an inert atmosphere.

However, it is possible and sometimes preferable to separately melt some of the elements and add them to the others, particularly when air casting. For example, the Bi and Sb could be melted at approximately 350° C. and the Ag and Cu could be melted separately at 1100° C. to insure the Cu is molten. The molten Ag and Cu is then added to the Bi and Sb mixture. This avoids subjecting the entire melt to the very high temperatures necessary to melt the Ag and Cu, which is particularly important when one of the elements can volatilize.

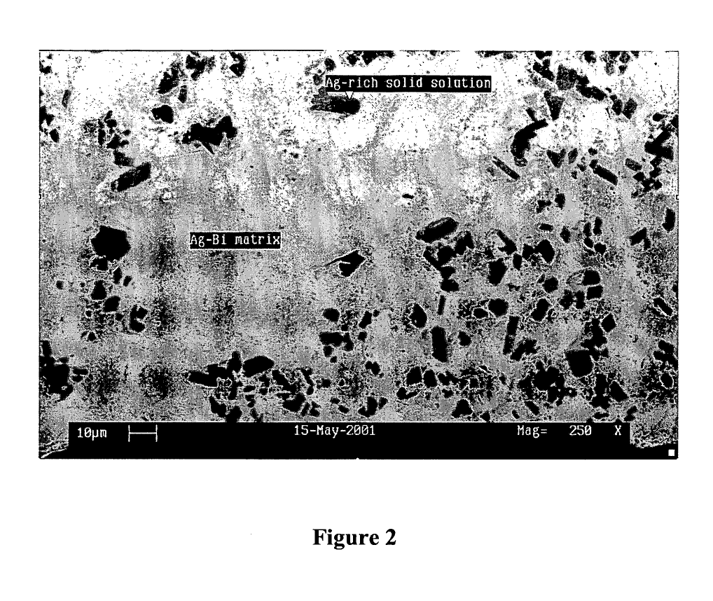

The molten mixture, or melt, is then quickly poured into a mold, allowed to solidify by cooling to ambient temperature, and fabricated into wire by conventional extrusion techniques, which includes heating the billet to approximately 190° C., or into ribbon by a process in which a rectangular slab is first annealed at temperatures between about 225-250° C. and then hot-rolled at the same temperature. Alternatively, a ribbon may be extruded that can subsequently be rolled to thinner dimensions. The melting step may also be carried out under air so long as the slag that forms is removed before pouring the mixture into the mold. FIG. 2 shows an electron micrograph, in which the Ag—Bi alloy appears to form a hypoeutectic alloy wherein the primary constituent (silver) is surrounded by fine eutectic structure. As can be seen from the electron micrograph, there is only negligible mutual solubility in the material, thus resulting in a more ductile material than bismuth metal.

In other embodiments, especially where higher liquidus temperatures are desired, contemplated compositions may include different percentages of alloying materials, such as Ag in the alloy in an amount of about 7 wt % to about 34 wt % and Bi in an amount of about 93 wt % to about 60 wt %. On the other hand, where relatively lower liquidus temperatures are desired, contemplated compositions may include similar materials in different percentages, such as Ag in the alloy in an amount of about 2 wt % to about 7 wt % and Bi in an amount of about 98 wt % to about 93 wt %. Some die attach applications may utilize a composition in which Ag is present in the alloy in an amount of about 5 wt % to about 12 wt % and Bi in an amount of about 95 wt % to about 88 wt %.

The at least one coupling element should create a chemical gradient for the reaction of bismuth with that at least one additional element. This effect may be small, but it will be usable, since the literature indicates that the NiBi₃ intermetallic grows via diffusion of the bismuth through the NiBi₃ layer. Elements can be added to the solder that will go into the intermetallic and slow the growth rate of the intermetallic. Calcium, strontium and barium form an intermetallic with the same ratio of metal to bismuth as NiBi₃, so those elements may form solid solution intermetallics that grow at a slower rate than NiBi₃. Antimony forms a complete solid solution with bismuth, so the addition of antimony to the solder should result in the formation of an Ni(Bi, Sb)₃ intermetallic that may have a slower growth rate. The addition of antimony may force the formation of a different intermetallic such as Ni(Bi, Sb) that has a slower growth rate. Small amounts of nickel may also be added, as mentioned earlier, to slow the dissolution of the nickel layer.

At least one additional element may be added, such as a transition metal, may also be added to the solder composition. This at least one additional element may aid in the coupling reaction or may affect the properties of the solder composition, such as by increasing or decreasing the thermal conductivity. Additional elements contemplated herein comprise zinc, nickel, copper and any other suitable transition metal. In some embodiments, zinc may be added in an amount up to about 10 weight percent. In other embodiments, copper may be added in an amount up to about 4 weight percent.

Where additional elements and dopants are added, it is contemplated that the at least one of the additional elements and/or dopants may be added in any suitable form (e.g., powder, shot, or pieces) in an amount sufficient to provide the desired concentration of the at least one of the additional elements and/or dopants, and the addition of the third element/elements may be prior to, during, or after melting the components for the binary alloy, such as Bi and Ag.

In one example, antimony can be added in small percentages (less than about 1%) to bismuth-silver alloys that contain copper. It has been surprisingly discovered that antimony alloying controls intermetallic growth and wets copper. Although antimony decreases thermal conductivity, the additional copper increases thermal conductivity. Although several alloys are contemplated, some of the most useful alloys are Bi10Ag0.5Cu0.5Ni—Ge, Bi10Ag10Cu0.06Ge, Bi10Ag0.08Ge, Bi9Ag9Sb—Ge, Bi9.9Ag1Sb0.08Ge, Bi10Ag0.05Cu0.05Ge, Bi10Ag10Cu0.5Sb0.05Ge, Bi26Ag2.1Cu0.05Ge and Bi10Ag5Cu0.5Sb0.05Ge.

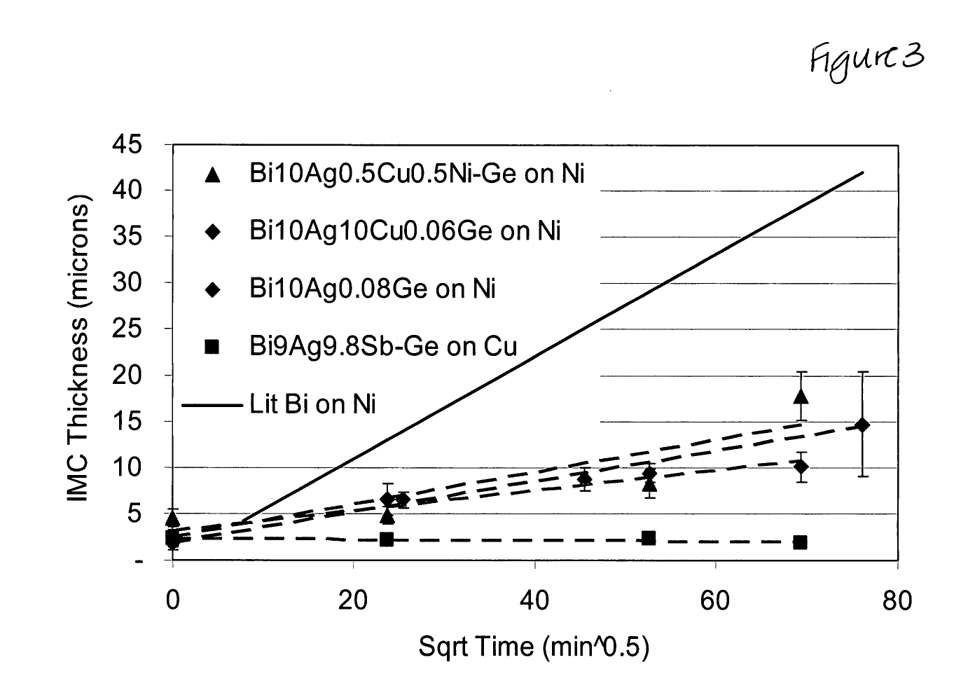

Several samples of alloys were measured for intermetallic growth versus time for aging samples at 150° C. For Bi9Ag9.8Sb—Ge, good intermetallic growth results where observed. No intermetallics were visually observed on nickel-plated surfaces. In addition, the intermetallics that developed on the copper surface either remained flat or decreased with time during high temperature aging. For Bi10Ag0.08Ge, Bi10Ag0.5Cu0.5Ni—Ge and Bi10Ag10Cu—Ge, it was discovered that intermetallics grow on nickel plating, but they grow at a slower rate than literature values for bismuth on nickel. For copper surfaces, no intermetallic growth was visually observed. FIG. 3 shows IMC thickness versus aging at 150° C.

The Bi26Ag2.1Cu0.05Ge was successfully cast at an estimated temperature of 450° C. When differential scanning calorimetry (DSC) was conducted on the material, it was determined that most melting/freezing due to the eutectic at about 260° C. and then there was a small freezing peak just below 400° C., as predicted. But, no higher peaks were observed.

It should be understood that the solder compositions and materials contemplated herein are substantially lead-free, wherein “substantially” means that the lead present is a contaminant and not considered a dopant or an alloying material.

As used herein, the term “metal” means those elements that are in the d-block and f-block of the Periodic Chart of the Elements, along with those elements that have metal-like properties, such as silicon and germanium. As used herein, the phrase “d-block” means those elements that have electrons filling the 3d, 4d, 5d, and 6d orbitals surrounding the nucleus of the element. As used herein, the phrase “f-block” means those elements that have electrons filling the 4f and 5f orbitals surrounding the nucleus of the element, including the lanthanides and the actinides. As used herein, the term “compound” means a substance with constant composition that can be broken down into elements by chemical processes.

It has been discovered that, among other desirable properties, contemplated compositions may advantageously be utilized as near drop-in replacements for high-lead containing solders in various die attach applications. In some cases, contemplated compositions are lead-free alloys having a solidus of no lower than about 240° C. and a liquidus no higher than about 500° C., and in other cases no higher than about 400° C. Various aspects of the contemplated methods and compositions are disclosed in PCT application PCT/US01117491 incorporated herein in its entirety.

At this point it should be understood that, unless otherwise indicated, all numbers expressing quantities of ingredients, constituents, reaction conditions and so forth used in the specification and claims are to be understood as being modified in all instances by the term “about”. Accordingly, unless indicated to the contrary, the numerical parameters set forth in the specification and attached claims are approximations that may vary depending upon the desired properties sought to be obtained by the subject matter presented herein. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the subject matter presented herein are approximations, the numerical values set forth in the specific examples are reported as precisely as possible. Any numerical value, however, inherently contain certain errors necessarily resulting from the standard deviation found in their respective testing measurements.

It should be particularly appreciated that these contemplated and novel compositions may be utilized as lead-free solders that are also essentially devoid of Sn as an alloying element, which is a common and predominant component in known lead-free solder. If tin is added to the novel compositions described herein, it is added as a dopant and not for the purposes of alloying. Moreover, while it is generally contemplated that particularly suitable compositions are ternary alloys, it should also be appreciated that alternative compositions may include binary (with small percentages of other metals), quaternary, and higher order alloys.

Consequently, and depending on the concentration/amount of the at least one additional element, it should be recognized that such alloys will have a solidus of no lower than about 230° C., more preferably no lower than about 248° C., and most preferably no lower than about 258° C. and a liquidus of no higher than about 500° C. and in some cases no higher than about 400° C. Especially contemplated uses of such alloys includes die attach applications (e.g., attachment of a semiconductor die to a substrate). Consequently, it is contemplated that an electronic device will comprise a semiconductor die coupled to a surface via a material comprising the composition that includes contemplated ternary (or higher order) alloys. With respect to the production of contemplated ternary alloys, the same considerations as outlined above apply. In general, it is contemplated that the third element (or elements) is/are added in appropriate amounts to the binary alloy or binary alloy components.

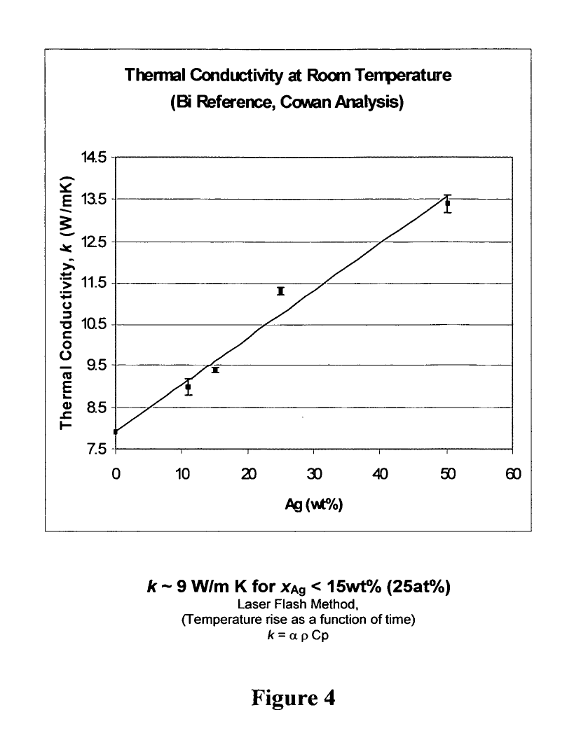

With respect to thermal conductivity of contemplated alloys, it is contemplated that compositions disclosed herein have a conductivity of no less than about 5 W/m K, more preferably of no less than about 9 W/m K, and most preferably of no less than about 15 W/m K. Thermal conductivity analysis for some of the contemplated alloys using a laser flash method indicated thermal conductivity of at least 9 W/m K is depicted in FIG. 4.

Methods of manufacturing and/or producing a solder composition comprising silver and bismuth have one step in which bismuth and silver are provided in an amount of about 98 wt % to about 60 wt % and about 2 wt % to about 34 wt %, respectively, wherein the at least one of zinc, nickel, germanium, copper, calcium or a combination thereof is present and in some embodiment, in an amount of up to about 1000 ppm. In a further step, the silver, bismuth, and the at least one of zinc, nickel, germanium or a combination thereof are melted at a temperature of at least about 960° C. to form an alloy having a solidus of no lower than about 262.5° C. and a liquidus of no higher than about 400° C. Contemplated methods further include optional addition of a chemical element having an oxygen affinity that is higher than the oxygen affinity of the alloy, such as germanium.

Layered materials are also contemplated herein that comprise: a) a surface or substrate; b) an electrical interconnect; c) a modified solder composition, such as those described herein, and d) a semiconductor die or package. Contemplated surfaces may comprise a printed circuit board, lead frame, or a suitable electronic component. Electronic and semiconductor components that comprise solder materials and/or layered materials described herein are also contemplated.

The at least one solder material, at least one coupling element and/or the at least one additional element may be provided by any suitable method, including a) buying the at least one solder material, at least one coupling element and/or the at least one additional element from a supplier; b) preparing or producing at least some of the at least one solder material, at least one coupling element and/or the at least one additional element in house using chemicals provided by another source and/or c) preparing or producing the at least one solder material, at least one coupling element and/or the at least one additional element in house using chemicals also produced or provided in house or at the location.

Applications

In the test assemblies and various other die attach applications the solder is generally made as a thin sheet that is placed between the die and the substrate to which it is to be soldered. Subsequent heating will melt the solder and form the joint. Alternatively the substrate can be heated followed by placing the solder on the heated substrate in thin sheet, wire, melted solder, or other form to create a droplet of solder where the semiconductor die is placed to form the joint.

For area array packaging contemplated solders can be placed as a sphere, small preform, paste made from solder powder, or other forms to create the plurality of solder joints generally used for this application. Alternatively, contemplated solders may be used in processes comprising plating from a plating bath, evaporation from solid or liquid form, printing from a nozzle like an ink jet printer, or sputtering to create an array of solder bumps used to create the joints.

In a contemplated method, spheres are placed on pads on a package using either a flux or a solder paste (solder powder in a liquid vehicle) to hold the spheres in place until they are heated to bond to the package. The temperature may either be such that the solder spheres melt or the temperature may be below the melting point of the solder when a solder paste of a lower melting composition is used. The package with the attached solder balls is then aligned with an area array on the substrate using either a flux or solder paste and heated to form the joint.

One contemplated method for attaching a semiconductor die to a package or printed wiring board includes creating solder bumps by printing a solder paste through a mask, evaporating the solder through a mask, or plating the solder on to an array of conductive pads. The bumps or columns created by such techniques can have either a homogeneous composition so that the entire bump or column melts when heated to form the joint or can be inhomogeneous in the direction perpendicular to the semiconductor die surface so that only a portion of the bump or column melts.

It is still further contemplated that a particular shape of contemplated compositions is not critical, however, it is preferred that contemplated compositions are formed into a wire shape, ribbon shape, or a spherical shape (solder bump).

Solder materials, spheres and other related materials described herein may also be used to produce solder pastes, polymer solders and other solder-based formulations and materials, such as those found in the following Honeywell International Inc.'s issued patents and pending patent applications, which are commonly-owned and incorporated herein in their entirety: U.S. patent application Ser. Nos. 09/851,103, 60/357,754, 60/372,525, 60/396,294, and 09/543,628; and PCT Pending Application Serial No.: PCT/US02/14613, and all related continuations, divisionals, continuation-in-parts and foreign applications. Solder materials, coating compositions and other related materials described herein may also be used as components or to construct electronic-based products, electronic components and semiconductor components. In contemplated embodiments, the alloys disclosed herein may be used to produce BGA spheres, may be utilized in an electronic assembly comprising BGA spheres, such as a bumped or balled die, package or substrate, and may be used as an anode, wire or paste or may also be used in bath form.

Also in contemplated embodiments, the spheres are attached to the package/substrate or die and reflowed in a similar manner as undoped spheres. The additional elements slow the consumption rate for the EN coating and results in higher integrity (higher strength) joints.

Among various other uses, contemplated compounds (e.g., in wire form) may be used to bond a first material to a second material. For example, contemplated compositions (and materials comprising contemplated compositions) may be utilized in an electronic device to bond a semiconductor die (e.g., silicon, germanium, or gallium arsenide die) to a leadframe as depicted in FIG. 5. Here, the electronic device 100 comprises a leadframe 110 that is metallized with a silver layer 112. A second silver layer 122 is deposited on the semiconductor die 120 (e.g., by backside silver metallization). Layer 112 may be electroplated Ni or electroless Ni and is sometimes omitted so that bonding is directly to the Cu leadframe. Layer 122 may be far more complex with layers of Ti and Ni (or Ni—V) between the die and the outer Ag layer. Au is also commonly used for the layer closest to the solder. The die and the leadframe are coupled to each other via their respective silver layers by contemplated composition 130 (here, e.g., a solder comprising an alloy that includes at least about 2% of silver, at least about 60% of bismuth, and at least one coupling element, wherein the at least one coupling element forms a complex with bismuth). In an optimum die attach process, contemplated compositions are heated to about 40° C. above the liquidus of the particular alloy for 15 seconds and preferably no higher than about 430° C. for no more than 30 seconds. The soldering can be carried out under a reducing atmosphere (e.g., hydrogen or forming gas).

In further alternative aspects, it is contemplated that the compounds disclosed herein may be utilized in numerous soldering processes other than die attach applications. In fact, contemplated compositions may be particularly useful in all, or almost all, step solder applications in which a subsequent soldering step is performed at a temperature below the melting temperature of contemplated compositions. Furthermore, contemplated compositions may also be utilized as a solder in applications where high-lead solders need to be replaced with lead-free solders, and solidus temperatures of greater than about 240° C. are desirable. Particularly preferred alternative uses include use of contemplated solders in joining components of a heat exchanger as a non-melting standoff sphere or electrical/thermal interconnection.

Electronic-based products can be “finished” in the sense that they are ready to be used in industry or by other consumers. Examples of finished consumer products are a television, a computer, a cell phone, a pager, a palm-type organizer, a portable radio, a car stereo, and a remote control. Also contemplated are “intermediate” products such as circuit boards, chip packaging, and keyboards that are potentially utilized in finished products.

Electronic products may also comprise a prototype component, at any stage of development from conceptual model to final scale-up/mock-up. A prototype may or may not contain all of the actual components intended in a finished product, and a prototype may have some components that are constructed out of composite material in order to negate their initial effects on other components while being initially tested.

As used herein, the term “electronic component” means any device or part that can be used in a circuit to obtain some desired electrical action. Electronic components contemplated herein may be classified in many different ways, including classification into active components and passive components. Active components are electronic components capable of some dynamic function, such as amplification, oscillation, or signal control, which usually requires a power source for its operation. Examples are bipolar transistors, field-effect transistors, and integrated circuits. Passive components are electronic components that are static in operation, i.e., are ordinarily incapable of amplification or oscillation, and usually require no power for their characteristic operation. Examples are conventional resistors, capacitors, inductors, diodes, rectifiers and fuses.

Electronic components contemplated herein may also be classified as conductors, semiconductors, or insulators. Here, conductors are components that allow charge carriers (such as electrons) to move with ease among atoms as in an electric current. Examples of conductor components are circuit traces and vias comprising metals. Insulators are components where the function is substantially related to the ability of a material to be extremely resistant to conduction of current, such as a material employed to electrically separate other components, while semiconductors are components having a function that is substantially related to the ability of a material to conduct current with a natural resistivity between conductors and insulators. Examples of semiconductor components are transistors, diodes, some lasers, rectifiers, thyristors and photosensors.

Electronic components contemplated herein may also be classified as power sources or power consumers. Power source components are typically used to power other components, and include batteries, capacitors, coils, and fuel cells. As used herein, the term “battery” means a device that produces usable amounts of electrical power through chemical reactions. Similarly, rechargeable or secondary batteries are devices that store usable amounts of electrical energy through chemical reactions. Power consuming components include resistors, transistors, ICs, sensors, and the like.

Still further, electronic components contemplated herein may also be classified as discreet or integrated. Discreet components are devices that offer one particular electrical property concentrated at one place in a circuit. Examples are resistors, capacitors, diodes, and transistors. Integrated components are combinations of components that that can provide multiple electrical properties at one place in a circuit. Examples are ICs, i.e., integrated circuits in which multiple components and connecting traces are combined to perform multiple or complex functions such as logic.

Solder compositions contemplated herein may also comprise at least one support material and/or at least one stability modification material, such as those described in PCT Application PCT/US03/04374, which is commonly-owned and incorporated herein by reference. The at least one support material is designed to provide a support or matrix for the at least one metal-based material in the solder paste formulation. The at least one support material may comprise at least one rosin material, at least one Theological additive or material, at least one polymeric additive or material and/or at least one solvent or solvent mixture. In some contemplated embodiments, the at least one rosin material may comprise at least one refined gum rosin.

Stability modification materials and compounds, such as humectants, plasticizers and glycerol-based compounds may also positively add to the stability of the solder composition over time during storage and processing and are contemplated as desirable and often times necessary additives to the solder paste formulations of the subject matter presented herein. Also, the addition of dodecanol (lauryl alcohol) and compounds that are related to and/or chemically similar to lauryl alcohol contribute to the positive stability and viscosity results found in contemplated solder paste formulation and are also contemplated as desirable and sometimes necessary additives to contemplated solder paste formulations. Further, the addition or replacement of an amine-based compound, such as diethanolamine, triethanolamine or mixtures thereof may improve the wetting properties of the paste formulation to the point where it is inherently more printable in combination with the stencil apparatus, and therefore, more stable over time and during processing. Dibasic acid compounds, such as a long-chain dibasic acid, can be also used as a stability modification material.

Thus, specific embodiments and applications of modified and/or doped solder materials utilized as electronic interconnects have been disclosed. It should be apparent, however, to those skilled in the art that many more modifications besides those already described are possible without departing from the inventive concepts herein. Moreover, in interpreting the specification, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

I claim:

1. A solder composition, comprising:
at least about 2% of silver,
at least about 60% of bismuth, and
at least one coupling element, wherein the at least one coupling element forms a complex with bismuth.

2. The solder composition of claim 1, comprising at least about 7% silver.

3. The solder composition of claim 1, comprising at least about 20% silver.

4. The solder composition of claim 1, comprising at least about 72% bismuth.

5. The solder composition of claim 1, comprising at least about 93% bismuth.

6. The solder composition of claim 1, wherein the at least one coupling element comprises calcium, strontium, barium or antimony.

7. The solder composition of claim 1, wherein the composition comprises at least one additional element.

8. The solder composition of claim 7, wherein the at least one additional element comprises a transition metal.

9. The solder composition of claim 7, wherein the transition metal comprises copper, germanium, zinc or nickel.

10. The solder composition of claim 1, wherein the composition comprises about 2 to 34% Ag, about 0.5-11% Cu, about 0.2-2.5% Sb, about 0.01-0.1% Ge, and the remainder Bi.

11. A layered material, comprising:
a surface or substrate;
an electrical interconnect;
the solder composition of claim 1; and
a semiconductor die or package.

12. The layered material of claim 11, wherein the surface or substrate comprises a printed circuit board, a lead frame, or a suitable electronic component.

13. A method of producing a solder composition, comprising:
providing at least about 2% of silver,
providing at least about 60% of bismuth,
providing at least one coupling element, wherein the at least one coupling element forms a complex with bismuth, and
blending the silver, bismuth and at least one coupling element to form the solder composition.

14. The method of claim 13, wherein providing at least about 2% of silver comprises at least about 7% of silver.

15. The method of claim 13, wherein providing at least about 60% of bismuth comprises at least about 82% bismuth.

16. The method of claim 15, wherein providing at least about 60% of bismuth comprises at least about 93% bismuth.

17. The method of claim 13, wherein the at least one coupling element comprises calcium, strontium, barium or antimony.

18. The method of claim 13, further providing at least one additional element and blending at least one additional element with the silver, bismuth and at least one coupling element to form the solder composition

19. The method of claim 18, wherein the at least one additional element comprises a transition metal.

20. The method of claim 19, wherein the transition metal comprises copper, nickel, zinc or germanium.

21. The method of claim 13, wherein the produced composition comprises about 2 to 34% Ag, about 0.5-11% Cu, about 0.2-2.5% Sb, about 0.01-0.1% Ge, and the remainder Bi.
